(19) United States
(12) Patent Application Publication
(10) Pub. No.: US 2014/0108308 A1
(43) Pub. Date: Apr. 17, 2014

(54) SYSTEM AND METHOD FOR COMBINING DATA FOR IDENTIFYING COMPATIBILITY

(71) Applicant: Social Data Technologies, LLC, Bozeman, MT (US)

(72) Inventors: Ryan Stout, Bozeman, MT (US); Andrew Cantino, San Francisco, CA (US)

(21) Appl. No.: 13/939,951

(22) Filed: Jul. 11, 2013

Related U.S. Application Data
(60) Provisional application No. 61/671,538, filed on Jul. 13, 2012.

(51) Int. Cl. G06N 3/08; G06N 99/00

(52) U.S. Cl. CPC G06N 3/08; G06N 99/005
USPC 706/12; 706/20

(57) ABSTRACT

A method and system for combining data for identifying compatibility, having the steps of accessing at least one data source to extract data from the at least one data source that substantially merges all user data, classifying the data using a classification system, generating a data vector for the data, storing the data vector in the classification system, assessing a user attribute vector to the user data, comparing the data vector and the user attribute vector to produce at least one relationship recommendation, and providing to the user the at least one relationship recommendation.

### CROSS-REFERENCE TO RELATED APPLICATIONS

This application claims the benefit of U.S. Provisional Patent Application No. 61/671,538 having a filing date of Jul. 13, 2012. The disclosure and teaching of the application identified above is hereby incorporated by reference.

### BACKGROUND OF THE INVENTION

The present invention is directed to a system and method for calculating relationship compatibility scores. The relationship compatibility scores are calculated from data extracted and combined from a variety of differing source origins and types. The present invention describes a method for normalizing and combining the data to allow a consistent relationship compatibility measure for a variety of purposes and tasks.

Many previous systems have generated a variety of methods for calculating relationship compatibility scores. Most commonly used in online dating systems, traditional approaches are based primarily on structured data sources of evaluation. Commonly those structured data sources are self-administered questionnaires, although variations in administration style and content differ widely. Such techniques pre-date computerization of the questionnaires but have become more robust and interactive with the World Wide Web (WWW). In fact, numerous companies provide a service for online dating using structured evaluation questionnaires relying heavily on self-reported answers.

Structured evaluation questionnaires are commonly constructed by psychologists or others professing to have specialized knowledge of a domain. The questionnaires are often long and contain repeated questions asked in different ways to determine consistency of responses. Those that are shorter without duplication are less valid, but are also sometimes used to simplify completion of the questionnaire. In both cases the responses are explicitly made and hence are subject to intentional or unintentional (e.g. from wording of the question) response bias. Due to the inherent bias of these questionnaires, they are never as accurate as intended.

Relationship compatibility scores have also been extracted from semi-structured data, such as browsing behavior, explicit tagging of content and other similar approaches. Semi-structured data avoids some of the problems of structured data since the partial structure in the data is generated for an activity that is distinct from its use in relationship calculations. Semi-structured data is, in essence, collected as a side effect of some other activity. For example, people tagging a photograph with attributes of the photographic composition commonly do this for future search discovery and retrieval. Those tags can then be used for alternate purposes beyond searching. Similarly, some activities have loose structure that can be collected when they occur. One example of an activity with loose structure would be browsing behavior on the World Wide Web. The web server and certain applications collect each page a user visits in succession. This recorded series of steps through the World Wide Web includes a time stamp, the uniform resource locator (or URL) defining the visited location, and any parameters sent to the location to alter its behavior (such as search terms). Each of these automatically generated pieces of content can then be used as informative about the user, as well as the specific sequence of web page views providing further information about the user as well as each page's connection to other pages.

Semi-structured data sources must be identified and extracted from their original use. At that point they may be turned into data used for other purposes. In contrast to structured data sources, the information extracted is less likely to contain biases since those biases would be too difficult for a contributor to consistently encode. However, this data tends to be less complete, more inconsistent, and very circumstantial to the final use. As such, more semi-structured data must be collected and analyzed to identify relevant relationship characteristics than with structured data sources. These techniques only became possible with the advent of more powerful computing systems.

Some recent systems have attempted to correlate the structured and semi-structured data to attempt to identify bias in the structured responses by comparing the results against the semi-structured data. For example, a structured questionnaire may be validated against browsing patterns. Someone explicitly responding to a question on vehicles may indicate they prefer family vans, but their web browsing history may show a preference for sports cars thus indicating a lower reliability of response. These recent techniques are still lacking in that they require the structured data collection and focus only on the validation of the structured information. They provide a poor user experience through the extra effort of a questionnaire and don't allow the expansion of attribute identification with the wider array of data available outside of the structured data.

An emerging area of work involves extracting patterns out of unstructured data. Unstructured data largely indicates freeform text, and may include content such as books, journals, documents, metadata, health records, audio, video, files, e-mail messages, Web pages, or word processor documents. Often the availability of Web APIs for accessing unstructured data focus on social services such as Twitter™ and Facebook™ text feeds, among other similar services.

Within unstructured text a variety of algorithms can extract relevant attributes with varying accuracy, said attributes including named entities/noun phrases, sentiment, personality, reading/writing level, and many of the other attributes that are sought after with the structured questionnaires. Unfortunately, no current system provides a method of calculating relationship compatibility scores using a combination of structured, semi-structured, and unstructured data to encompass the variety and expanding as well as dynamic nature of the attributes available to characterize relationship compatibility measures.

Further, those systems which do capture some aspect of relationship compatibility scores have a flawed metric for algorithm feedback. Current feedback approaches validate their algorithmic success by feeding back into the calculations “successful” relationships that result from interaction with a relationship compatibility system. This feedback method is incestuous in that it is biased toward the relationships only of those who have used the relationship algorithm and not the larger universe of successful relationships. Unfortunately, no current system provides an analysis of successful relationships identified in the absence of interaction with a relationship compatibility recommendation system. Such information is readily available from certain social graphs and can be used as yet another semi-structured information source for compatibility calculation as well as an external validation measure to the ongoing tuning of an unsupervised relationship compatibility algorithm. Similarly, information about relationships could also be collected in other surreptitious (intentionally or through accidental processes) methods and used in a manner that is either training or matching.

Finally, the interaction with relationship compatibility scores is somewhat limited in the current art. These compatibility scores are primarily used for a single purpose, whether that purpose is online dating, advertising, product/service/job recommendations, or the like. Since current semi-structured and unstructured data sources allow the extraction of a richer set of attributes about an individual (or product, service, job, etc.), a well-constructed relationship compatibility system should be able to identify the best type of relationship to recommend. For example, online dating matches should not be offered to a happily married individual, but perhaps that married individual is unemployed and could be matched to an available job posting while within the same service an employed single individual may receive an online dating recommendation. Similarly, if such a system were to be a premium service requiring a fee for use, the relationship compatibility algorithm could be set to provide a compelling restricted view of the relationships or data available to demonstrate the potential value a paid user may receive from using the relationship compatibility system.

Thus, all current systems lack the inventive aspects described herein. Current systems do not extract relevant information from multiple different types of data sources, including structured, semi-structured, and unstructured data. Current systems do not process said information using a variety of techniques to allow a consistent calculation of relationship compatibility. Current systems do not provide a variety of presentation views of the relationship information, whether simply descriptive about the individual or the individual's close friends identified in a social graph, or other incentive information to entice the paid usage of a premium service. Current systems do not provide a data driven workflow processing of the most relevant relationship types based upon the needs of the user but rather focus on a single type of relationship suggestion for all users.

### SUMMARY OF THE INVENTION

The present invention is directed to a system and method for identifying compatible relationships and recommending those relationships which would be most successful to an individual. The present invention enables (1) the extraction of relevant relationship features for an individual and a potential match using multiple sources of data of varying types and qualities. Said data (2) informs various attributes of a successful relationship as determined by other successful relationships that were not influenced by the current recommender system. Said attributes may include features which must be present and positive (or negative) in both sides of the relationship, those that must be positive (or negative) in only one side of the relationship, those that must be opposite among sides of the relationship, those that must be present or absent to fulfill a multi-party relationship (such as in employment or team building), and the like. Said relationship (3) is either recommended and ranked in comparison to other relationships or abstracted into incentive information to entice an individual into paying for a premium service. Finally, said relationship recommendation (4) is provided via a workflow system based upon said multiple sources of data to present the most relevant relationship (which may also be a natural relationship) match type to an individual, where relationship types may vary amongst dating recommendations, job recommendations, advertising recommendations, product or service recommendations, and the like.

While the present invention describes the extraction, calculation, and presentation of relationship compatibility recommendations using a variety of algorithmic techniques from specific types of data sources and types, one of ordinary skill in the art can easily identify alternative data sources or algorithmic processes which may provide equally valuable input into relationship compatibility recommendations.

### BRIEF DESCRIPTION OF THE SEVERAL VIEWS OF THE DRAWINGS

In the accompanying drawings, which form a part of the specification and are to be read in conjunction therewith in which like reference numerals are used to indicate like or similar parts in the various views:

FIG. 1 is a schematic of the complete system, including both the classification and modeling portions as well as the user path;

FIG. 2 is a detailed schematic of the classification system;

FIG. 3 is a detailed schematic of the topic modeling system;

FIG. 4 is a flow chart of the abstract process embodied by the schematic diagram in FIG. 1;

FIG. 5 is a flow chart of the classification engine initialization shown in FIG. 2;

FIG. 6 is a flow chart of the topic modeling engine as shown in FIG. 3;

FIG. 7 is a flow chart of the relationship modeling and feedback engine as represented diagrammatically in FIG. 1 and abstractly in FIGS. 2 and 5;

FIG. 8 is a flow chart of the user path through the system shown in FIG. 1 and in more detail than FIG. 4;

FIG. 9a is a flow chart for the calculation of relationship pairs and ranking the results of the relationship match quality;

FIG. 9b is the equivalent flow chart to FIG. 9a but with reference to calculating multi-member team relationships;

FIG. 10 is a flow chart showing the combined interaction of the off-line and run-time processing for relationship matching where at least one member of the relationship is a product, service, or similar abstract entity;

FIG. 11 is an alternate algorithmic approach to FIG. 10; and

FIG. 12 is a block diagram of an example embodiment of a computer system upon which embodiments inventive subject matter can execute.

### DESCRIPTION OF THE PREFERRED EMBODIMENT OF THE INVENTION

The present invention is directed toward a system and method for calculating relationship compatibility scores. Relationship compatibility, as commonly considered, can be used for identifying a pair of people who would make a good romantic couple or a pair or group of people who would make a good team. However, relationship compatibility could also be used in the more general sense to find good matches between a person (or people) and an animal pet, inanimate object, a job or service, or even an abstract concept.

To construct a measure of relationship compatibility, certain information must be known about each potential participant in the potential relationship. This information can come from a variety of sources, where those sources may even be different for each potential participant in the potential relationship. Further, the different sources may provide similar or different information for each potential participant. A robust calculation must include as many sources of information as possible for each potential participant to provide the most accurate and cross-validated information about each potential participant. Notably, in the present invention we use the term “cross-validated” in a flexible manner to include traditional statistical cross-validation approaches where a single data source is partitioned for training and testing a model. In the present invention we also expand that definition to include using alternate distinct data sources generating the same sort of data to compare against each other in a similar fashion to traditional cross-validation.

Any system that attempts to incorporate multiple distinct data sources must include methods for normalizing the data into comparable ranges for calculation. Numerous methods are commonly used for this type of calculation, and methods differ depending on the type of source data and the intended outcome. With the advent of improved storage devices and the popularity of, in particular social network information, rich sources of large amounts of data are now available in a manner that was previously unconsidered.

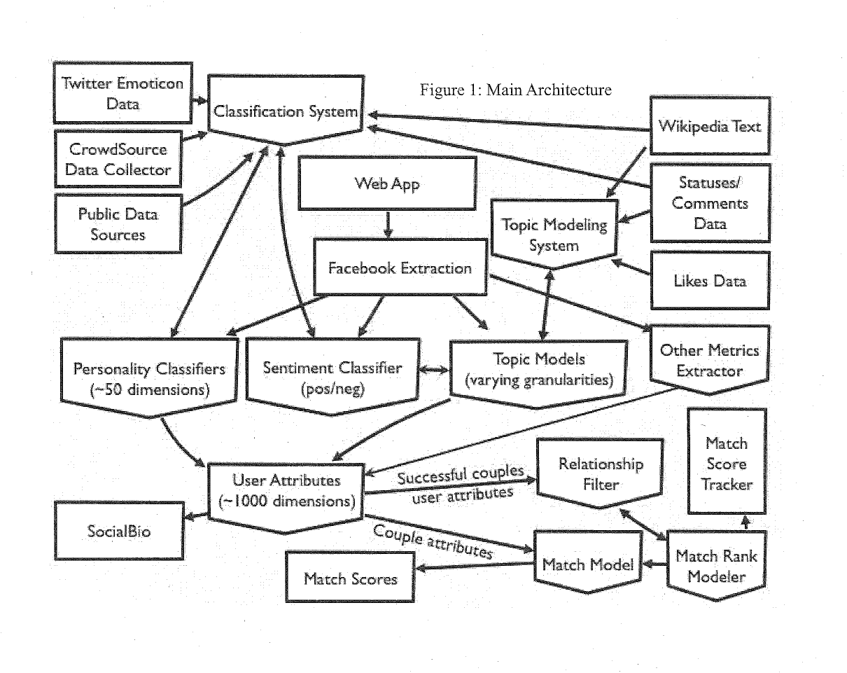

The present invention, as shown schematically in FIG. 1, is preferably implemented to consume data from a variety of social data sources via their publically accessible application programming interfaces (APIs) or through custom resource feeds built to extract public data. Preferred source information includes (but is not limited to) Twitter™, Facebook™, and Wikipedia™. In addition, proprietary information sources are used, both from standard or premium sources and from custom aggregation of information.

As should be evident to one of ordinary skill in the art, specific content references in FIG. 1 such as Twitter™, Wikipedia™, Facebook™ and the like should be taken as representative. The present invention considers multiple other content sources as relevant data input options.

### Data Sources

In practice each data source provides distinct types of information from the other sources. For example, Twitter™, a social network allowing users to publically post short status messages, can be used to identify text associated with emoticons (textual representations of emotion, such as the smiley face composed of a colon “:” a dash “-” and a parenthesis “)” to construct “:-)”). An assumption that the emoticon, representing a variety of emotions, can be associated with either nearby words or an entire Twitter™ message (called a “tweet”), thus identifying the sentiment associated with specific words or phrases. By statistically processing a large number of emoticon-containing tweets, certain correlations of words and phrases with emoticon-derived sentiment can be used to construct a dictionary of words and phrases with particular sentiments.

Importantly, this approach of statistical correlation has both strengths and weaknesses. Notably, the weakness is that the correlations are not based on an understanding of the meaning of the various words and phrases. Traditional methods that use meaning-based identification of sentiment with words thus have a higher reliability when identifying sentiment from words. However, due to the human cost of creating a dictionary of matching words and sentiment in the traditional method, it should be obvious that the automated approach will offer sentiment scores for a much larger vocabulary of words and phrases than a manually annotated sentiment dictionary. Thus, the statistical correlation approach for identifying sentiment has the strengths of creating a larger sentiment dictionary; said larger dictionary can include uncommon words or phrases as well as foreign language words and phrases. In addition a statistical approach is more able to capture and identify new or emerging uses that arise from informal language, specific contextual usages, and even acronyms or non-words. Consider, for example, the emergence of text messaging abbreviations such as “lol” to mean “laughing out loud” and clearly having a positive sentiment, or alternatively, current events in the context of, say, a company name such as British Petroleum. In this latter example, the common moniker of “BP” for British Petroleum could be identified with negative sentiment after an oil spill. While these words, phrases, abbreviations and the like could be easily added to a manually crafted sentiment dictionary, the responsiveness of an automated statistical approach has the advantage of faster inclusion at lower cost and is thus more responsive to the rapidly changing nature of public discourse than would otherwise be available.

In addition to using Twitter™ for creating a sentiment dictionary, Wikipedia™, an online crowd-sourced encyclopedia, can be used in a similar manner as above to identify named entities and noun phrases of importance by identifying the various encyclopedia topic pages. Named entities and noun phrases are useful for identifying topic interests in free-form text, and existing approaches to identify this type of information are fraught with difficulty.

Similarly, Facebook™, a social network allowing people to post both public and private status messages as well as identify “likes” (an indicator of affinity for a topic or object, as well as a subscription to information about that topic or object) of a variety of things from status messages to topic pages to WWW pages, can be used to augment the Wikipedia™ identified named entities, augment the Twitter™ identified sentiment dictionaries, or cross-validate against either of those sources. Through cross-validating similar information from a variety of sources, automatic extraction algorithms can improve accuracy and reliability of data.

Each of the above discussed data sources also provide additional contextual information not yet discussed. Twitter™ and Facebook™, for example, include a social graph that is available through APIs that allow the identification of connections and natural relationships to other users within the respective system. Depending on the data source, such connections provide different information about an individual in the social network system. Wikipedia™ can be used in a similar manner to identify the social graphs of contributors (of which there are proportionally few), but due to the extensive use of Hypertext within Wikipedia™ articles to link with other articles, information or concept relationships can be extracted. Thus, one can easily discover interconnections and natural relationships between individuals and other individuals, between individuals and topic interests, and between even inanimate objects.

While the above discussion was directed specifically at one type of extraction of information from a large source of data, numerous other similar approaches could be identified both for the particular source and for alternate sources. One of ordinary skill in the art could identify specific data sources and the data that could be extracted from them to use for other secondary purposes unintended by the original data provider. For example, news feed data could be used to identify common headlines associated with similar stories and determine synonym words for blocks of text, or provide methods for automatically summarizing blocks of text perhaps using words that don't exist within the text. Thus the preceding discussion is informative about likely approaches for extracting information from currently available sources, but is not intended to be restrictive to either the approach or source of data.

### Classification and Modeling

Of note, for the purposes of the present invention, classifiers and regressors will be used interchangeably. For those skilled in the art, one can recognize the distinction between the two approaches based upon the types of data processed or produced. For simplicity it is assumed herein that the appropriate class of algorithm, classifier or regressor, would be selected based upon the specific data needs.

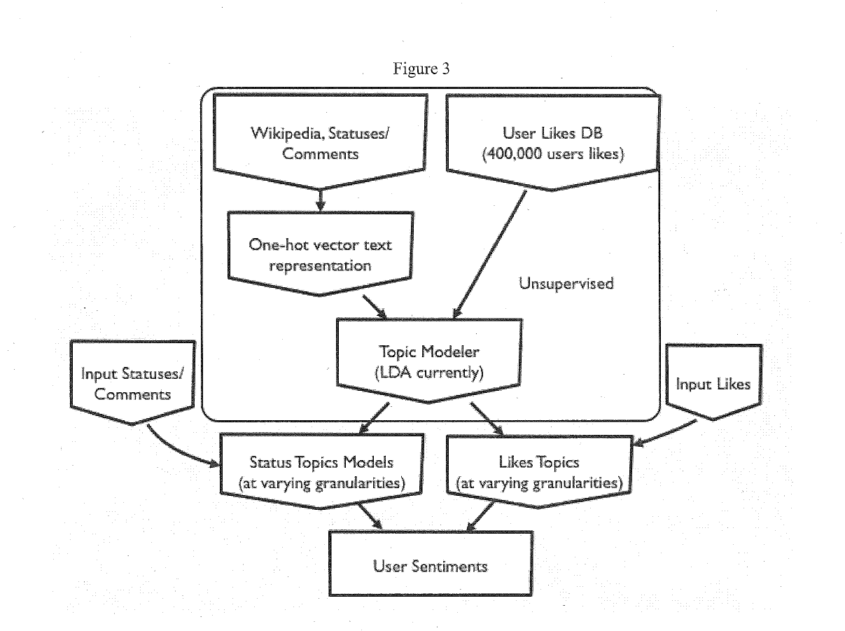

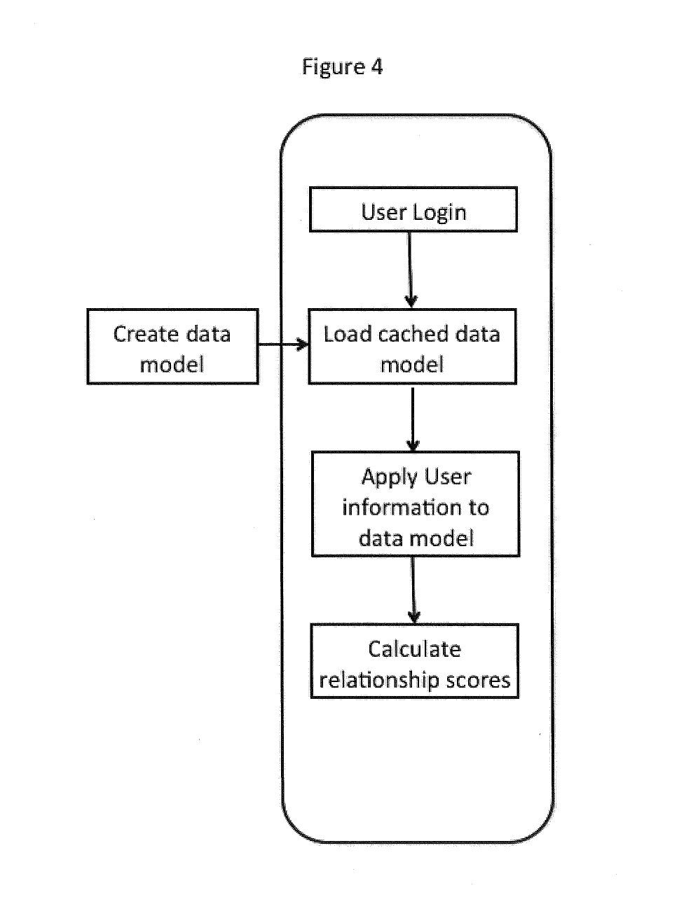

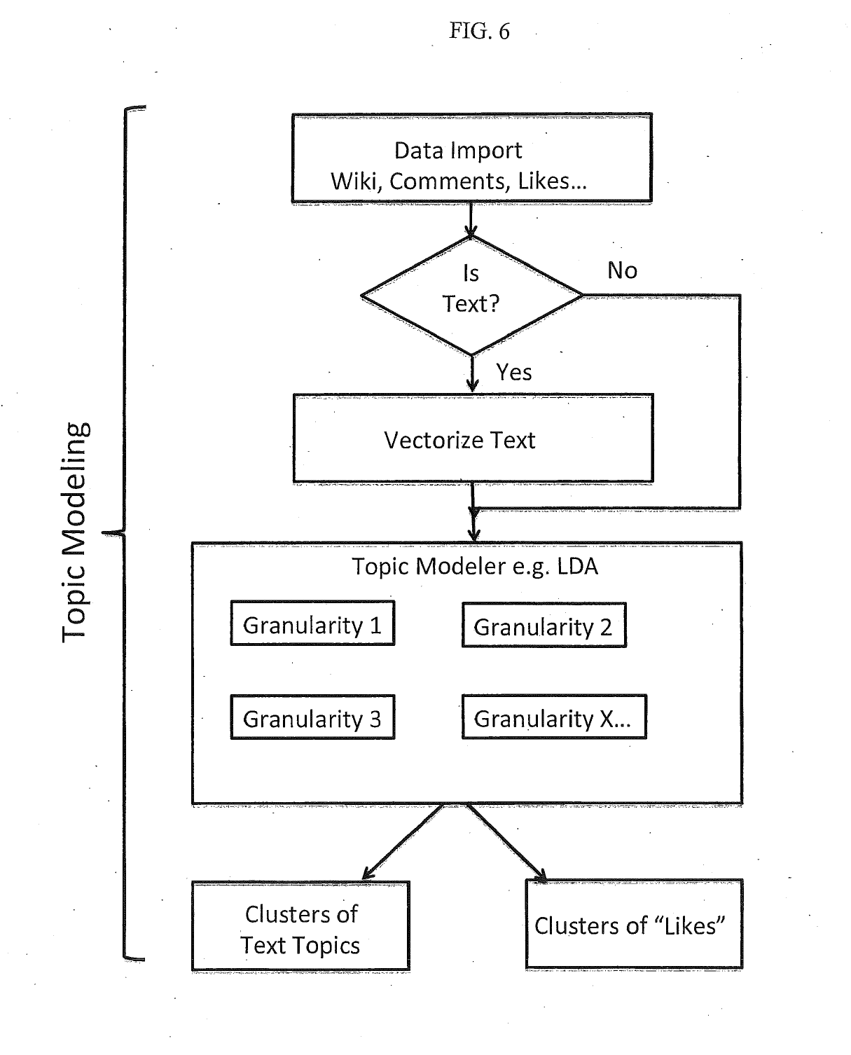

Importantly, each of the aforementioned data sources is simply a raw data source from which data of various types may be collected and analyzed. However, independent and raw extracted information is of limited use. In the present invention the various extracted data is passed through classifiers, regressors, and topic models to provide various higher-order understandings relevant to individuals where a relationship is needed. For instance, a topic modeling system as shown schematically in FIG. 3 and operationally in FIG. 6 can take information from Wikipedia™ text extraction, Twitter™ status updates, and Facebook™ status updates and “like” data to generate different granularities of topic interests.

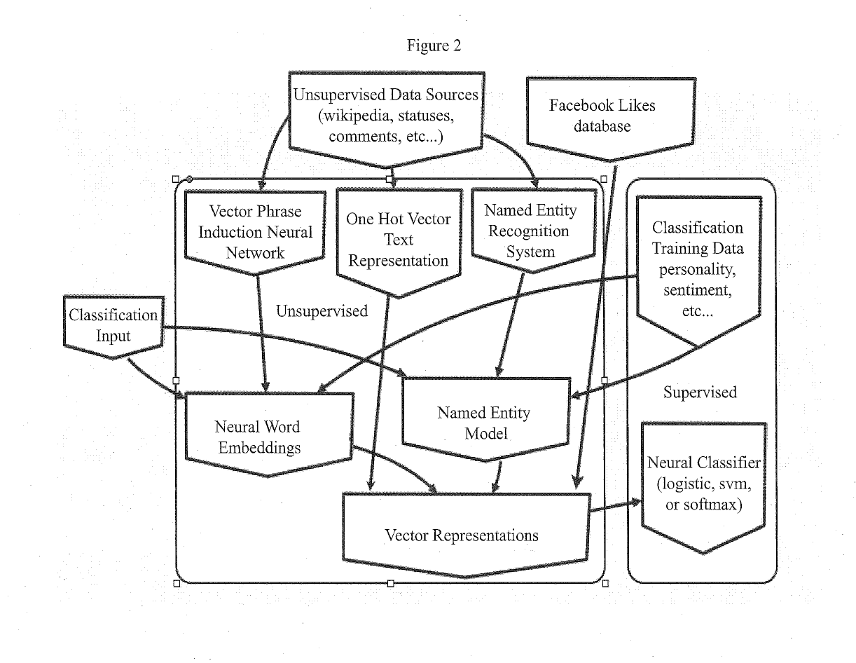

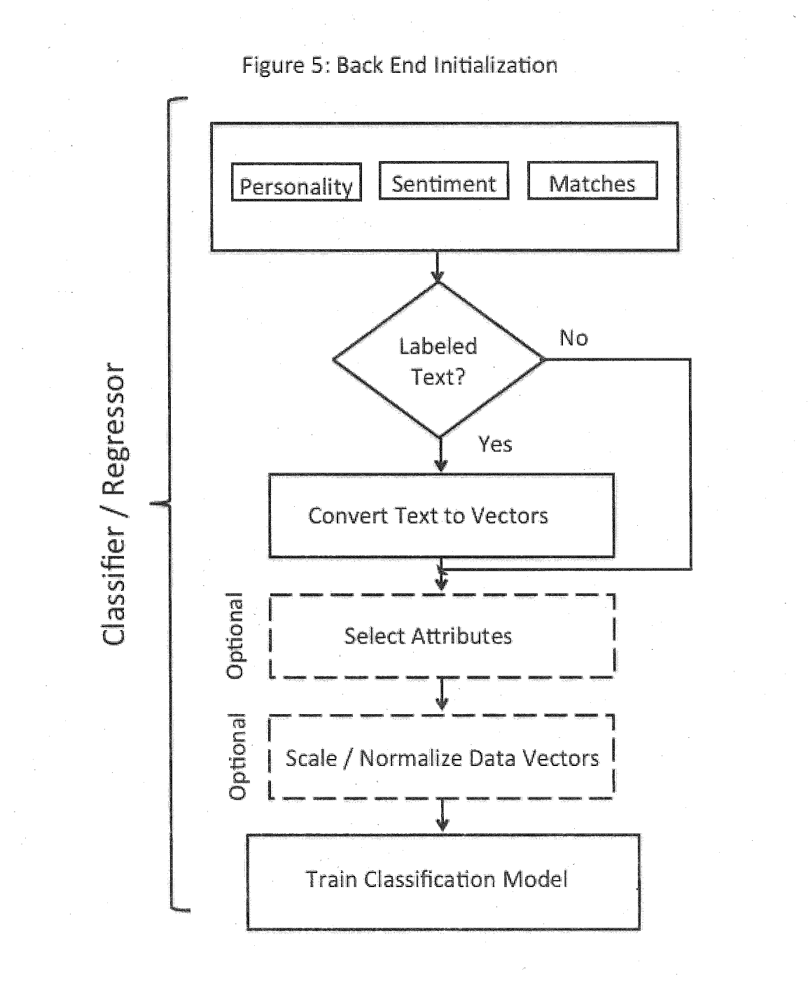

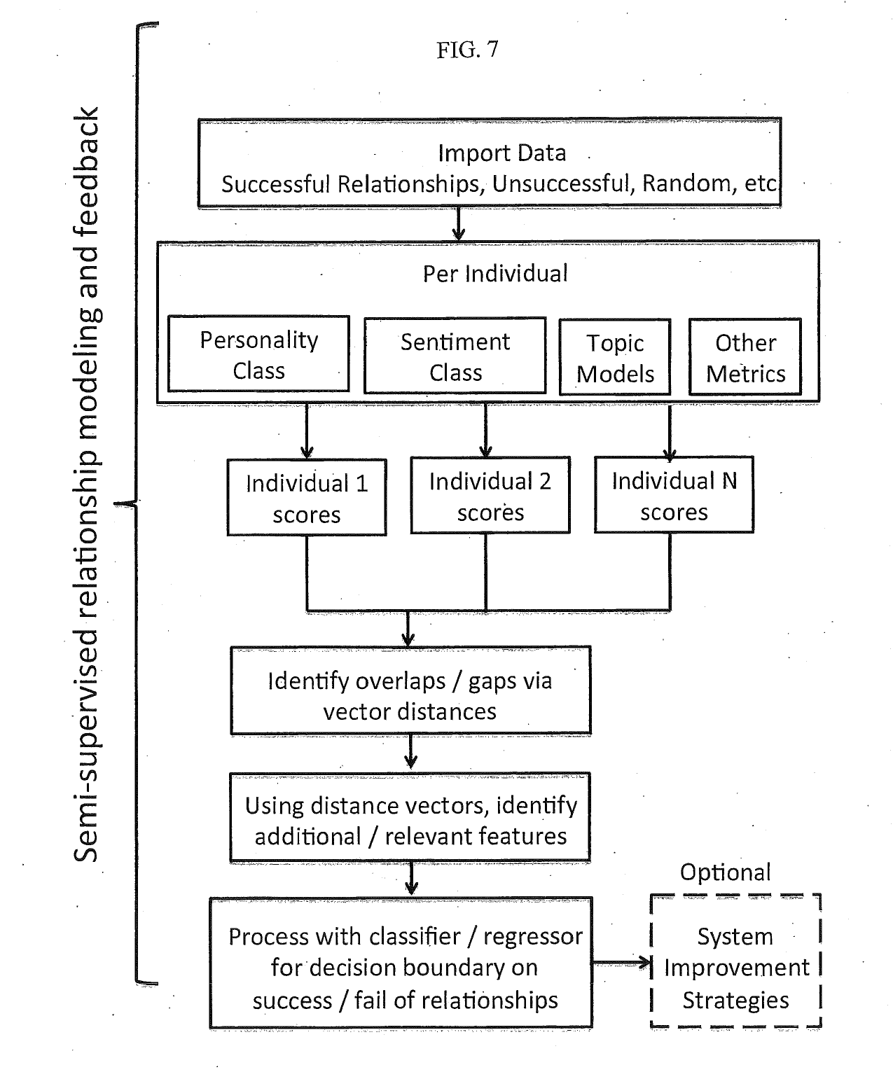

In the preferred embodiment of the present invention, the classification and modeling steps occur to generate a general model that is then later queried with an individual user's attributes as shown schematically in FIG. 2 as well as operationally in FIGS. 5 and 7. Alternate approaches are considered, including generating the models in the same step as querying against a user's attributes, and one of ordinary skill in the art can recognize the equivalence of said variances differing only in efficiency but not in kind.

Thus, a topic modeling system as shown in FIG. 6 can generate a high-level set of, for example, 100 common topics. It can also generate a mid-level set of, for example, 1000 more specific topics, and a detail-level set of say, 10,000 very specific topics. With various granular levels of topics the system can compare higher level and lower level similarities between potential members of a relationship.

In the present invention topic modeling as shown in FIG. 3 is implemented using an unsupervised algorithm that validates between data sources and generates multiple distinct model outcomes. Thus, the unsupervised topic modeling system uses Wikipedia™ as well as Facebook™ statuses and comments to generate a text vector which is then processed in addition to the Facebook™ “like” information (also treated as a vector in the preferred embodiment). It is possible to use an algorithm such as latent Dirichlet allocation (LDA) to explain why some parts of the data are similar. This algorithm, in the preferred embodiment, can then generate distinct models for status topics and “likes” topics. These models can then be independently used to tag or classify new incoming status or “like” items. Such topic models can be directly used for sentiment, ontology identification, or numerous other purposes. In addition, the “like” and text vectors could be combined for processing, as well as numerous algorithms exist in addition to LDA that could be used in a similar fashion as should be obvious to one of ordinary skill in the art. For example, specific algorithms that may be used for encoding text vectors include, but are not limited to: the bag of words model, named entity vectors, and neural word embeddings. Encoded text vectors can the by classified using specific algorithms that include, but are not limited to: naive Bayes, decision trees (J48, C4.5), support vector machines/support vector regression, neural networks (including convolution, recurrent, etc.), deep learning/deep architectures (stacked auto-encoders with softmax, stacked restricted Boltzmann machine's), ensemble/boosting methods, and numerous others. Similarly, topic models can be constructed using a variety of techniques including: k-means, latent semantic analysis (LSA), latent Dirichlet allocation (LDA), pachinko allocation (an extension to LDA) and others as obvious to one of ordinary skill in the art.

Once a topic model is generated, that topic model can provide structure to a classification system that can be used to provide a richer picture of an individual and their relevant dimensions upon which to compare for relationships as shown in FIG. 1. The classification system uses the topic models as well as the various raw and unsupervised extracted data as well as manually generated and supervised training data in an unsupervised fashion to generate an abstract representation of relevant relationship features.

The present system is preferably implemented to include in the classification system a neural network and a named entity recognition system in conjunction with a word frequency vector. The preferred embodiment uses a vector phrase induction neural network to generate neural word embeddings. Of course, one of ordinary skill in the art can identify alternative algorithms and embeddings that would function for this purpose as well. Similarly, the named entity recognition system can come from a number of methods obvious to one of ordinary skill in the art, whereas the preferred embodiment uses extracted information from Wikipedia™ and similar sources. Said named entity recognition system generates a named entity model.

As shown in FIGS. 1, 2, and 7, the classification system is then used with inputs from user information in conjunction with additional training data, such as personality inventories, sentiment calculation, and other heuristic and hand-crafted attribute identifiers. These inputs are processed against the multiple calculated classification models to generate a vector of relevant user attributes. Finally, the user vectors are processed with a classifier which is informed from relationship success data. Such a classifier in the preferred embodiment is a neural classifier, and one of ordinary skill in the art could identify a variety of neural classifiers or non-neural classifiers which would function for this purpose.

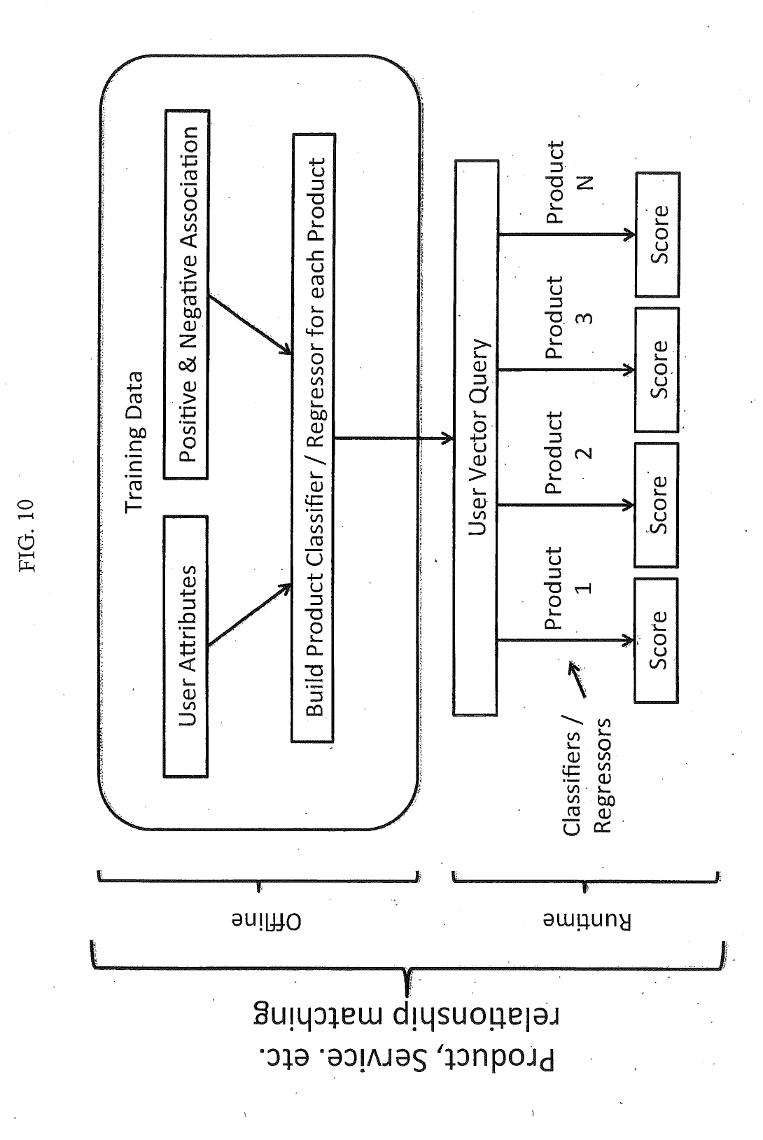

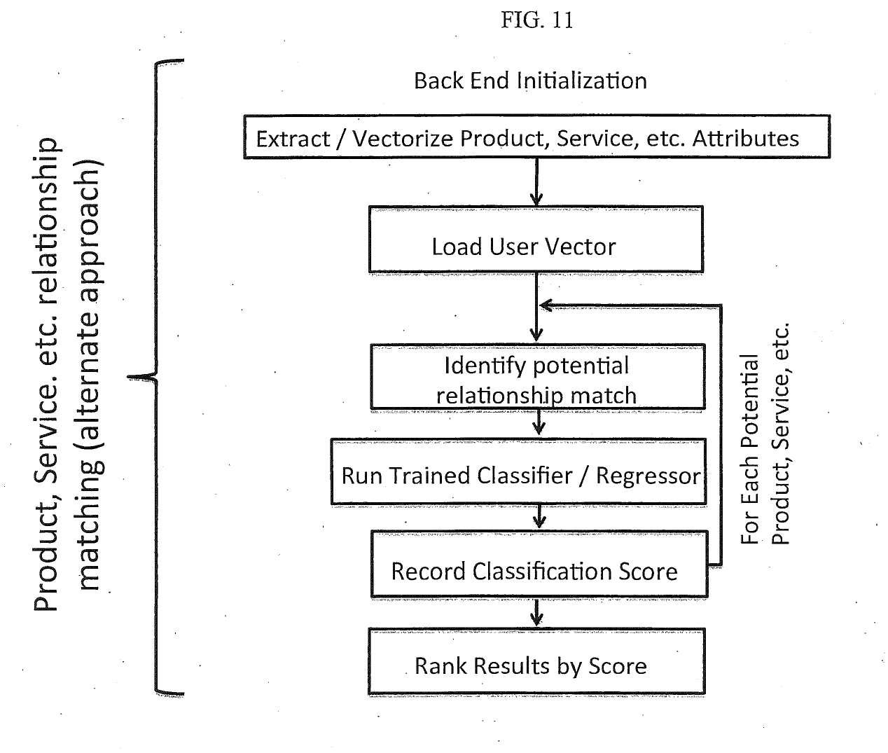

The relationship feedback as shown in FIGS. 7, 10, and 11 is a key component of the present invention. Unlike previous technologies, the relationship feedback system uses “in-wild” or natural relationship information as training data. Rather than simply relying on feedback from users of the system that use the system to begin a relationship, the present invention collects data about successful relationships from sources external to the system. For example, Facebook™ provides a social graph of connected friends. Each of these friends information may include a relationship status. Sometimes a social graph will include both members of a romantic relationship. When such a discovery is made the attributes of each individual in the “in-wild” relationship is processed to find key commonalities and differences. Similarly, through some data sources divorce information is available and can be used to identify unsuccessful relationships and the similarities and differences between the individuals involved. In the absence of divorce data, random pairs of individuals could be used to simulate expected unsuccessful relationships.

The relationship process as shown in FIG. 7 in the preferred embodiment includes, but is not limited to (e.g. is built to allow additional measures as needed), the processing of an individual's attributes against personality classifiers, sentiment classifiers, topic models, reading/writing level measures (such as Flesch/Kinkaid or Gunning Fog), age, education level (high school, 2 year, 4 year, masters, PhD), college education type (community college, state, ivy league, etc.), multiple colleges (boolean), travel interests, religion, political match, locale, custom writing style checks (slang, curse words) and others. For each individual in the relationship (including multi-member team relationships), a score is generated using the various classifications and models. These scores are then compared to identify key overlaps and gaps to identify which relationships are likely to match previously trained relationships. These overlap and gap comparisons are performed on the user attribute vectors in the preferred embodiment, but may be done using other methods obvious to one of ordinary skill in the art. In the preferred embodiment the attribute vectors are compared using a distance measure, such as cosine distance, to identify additional and/or relevant features for a successful or unsuccessful relationship. Finally these distance measure and relevant features are processed with a classifier or regression algorithm to identify the decision boundary on the predicted successfulness of the potential relationship. One of ordinary skill in the art could easily identify numerous classifiers, regression approaches, or other algorithms that would apply to discriminate between the likely successful and unsuccessful relationship participants.

An optional step that is useful to produce ongoing improvements to the system is recording the system performance metrics, such as the match score distance, to allow a system administrator to periodically monitor and adjust the system performance as required.

### User Processing

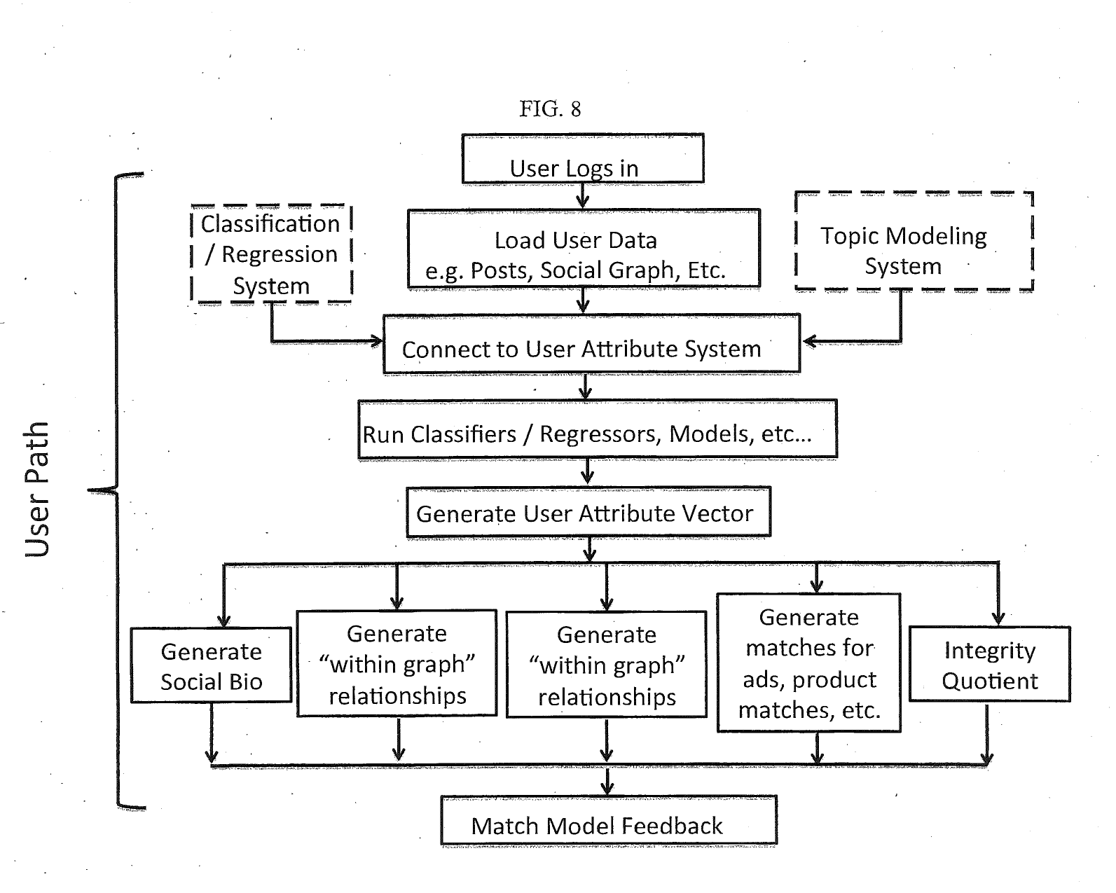

The preceding description involved the initial system configuration to allow individuals to use the relationship matching engine. Here we discuss the processing that occurs with each user interaction with the relationship recommendation system as shown in FIGS. 3 and 8. The present description of the preferred embodiment is via a Facebook™ application, but as should be obvious to one of ordinary skill in the art, alternate approaches would be equally valid, including dedicated applications, mobile applications, hard wired terminals, web sites, and the like.

When a user logs in to Facebook™ and accesses the relationship application, the relationship application accesses the user's available information including any free-form text posts and comments made by the user (or about the user), the list of “likes” affinity indicators the user has made, the social graph of all the user's connections to other users, and potentially pictures, videos, and other data available for review exposed to the application. This data is then connected with the relationship engine which is loaded and configured with the various classification and topic modeling systems as previously described. The user data is then processed by the various classifiers, models, and the like to generate a user attribute vector. This user attribute vector contains the relationship model's ranked set of important values relevant to the current user.

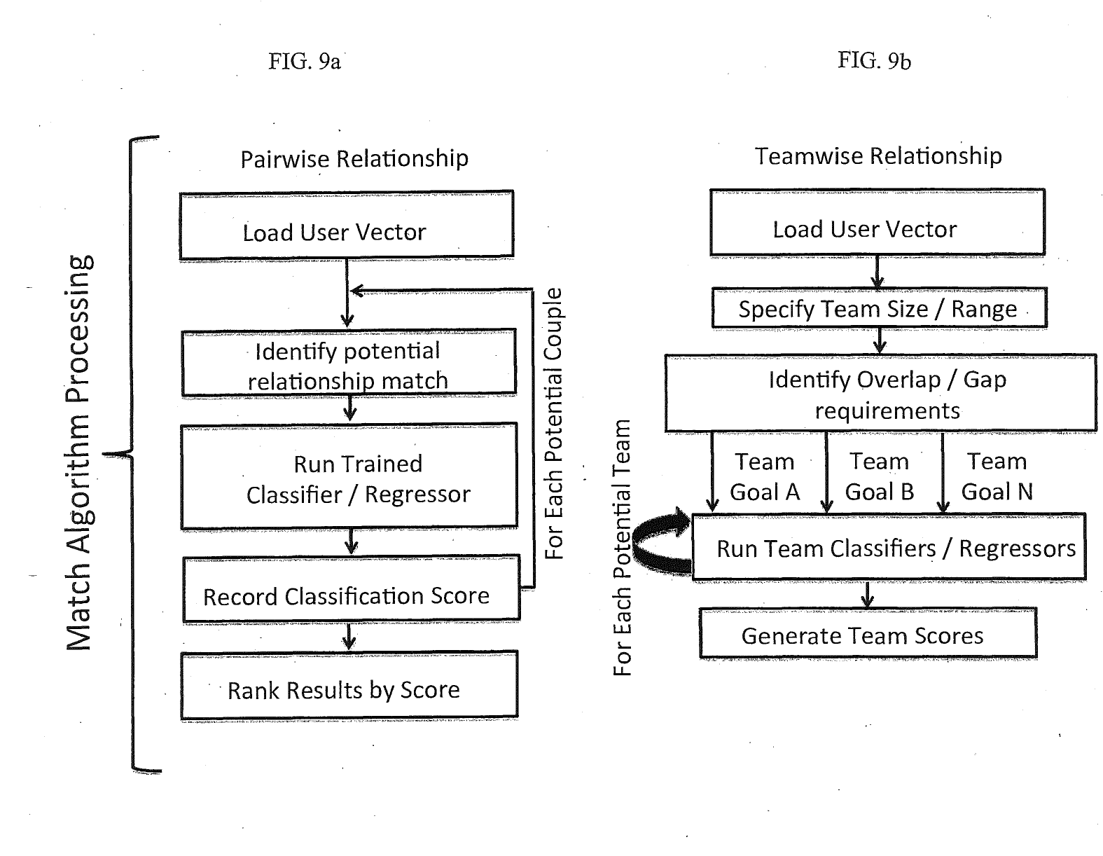

As shown in FIG. 9, matches can proceed in a number of ways depending on the type of relationship comparison—either pairwise or with multiple members within a single relationship. FIG. 9a shows one method of processing pairwise matches while FIG. 9b shows one way how a multi-part relationship for a team could be constructed.

At this point the system may provide one or more outputs to the user, depending on system configuration of business rules. In one embodiment there is only one type of recommendation available via the application, while in other embodiments there are multiple recommendation types depending on the business needs configured by the application administrator. In the preferred embodiment users who have paid to access the application receive one type of recommendation (e.g. potential romantic dating matches), while those who have not paid to access the application receive a personal summarized biography based upon their various attributes or alternatively show a limited ranking of their similarity to other friends in their social graph. The present invention also considers the significant importance of having the business decision additionally driven by attributes from the user attributes, such as offering a job recommendation to someone who is unemployed but not to someone who is employed, or a romantic dating recommendation to someone who is single but not someone who is in a relationship.

The various presentation displays that the user may be presented with include, but are not limited to, (a) a social biography describing the various important distilled and summarized attributes of the user, (b) a display of the various relationships within their social graph that are potential matches or existing matches or ranked friendships, (c) a display of potential relationships outside of their current social graph which may be good relationships (e.g. nearby compatible romantic partners), (d) potential team mates, (e) relevant advertising, product or service recommendations, job matches, apartment/house/roommate suggestions, traveling companions (e.g. airline seat mates, etc.), office mates, or any number of other more abstract relationship suggestions or (f) any number of other distillations of the user attributes in the context of their social graph or the larger system's information.

After supplying the relevant outcome to the user, the system, when recommending a relationship of some sort (e.g. options b, c, d, e from above), will then pass the recommended relationship recommendation and whether it was chosen back into the match model for “intra-system” relationship feedback. As previously noted, the relationship feedback can be used to improve overall system performance.

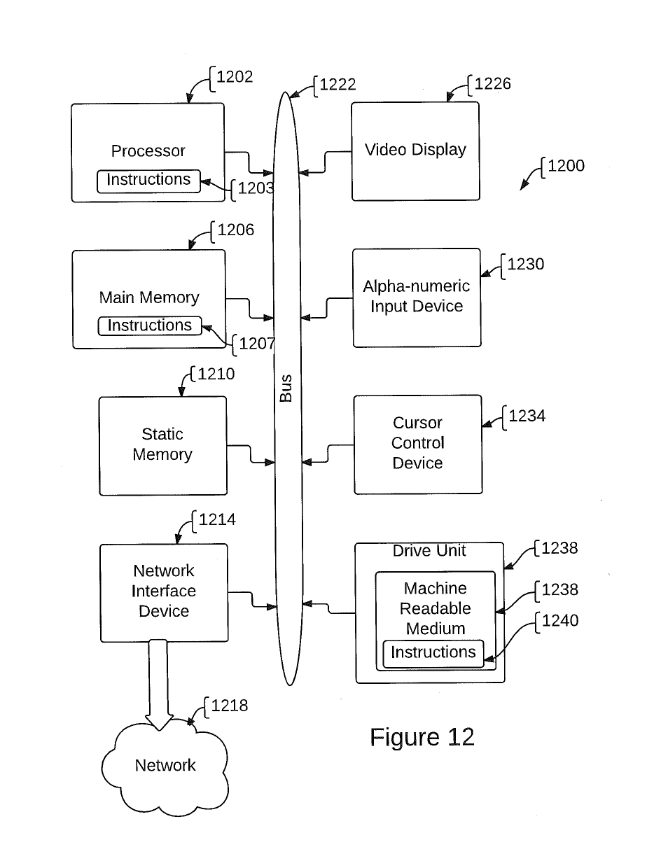

FIG. 12 is a block diagram of an example embodiment of a computer system 1200 upon which the embodiments inventive subject matter can execute. The description of FIG. 12 is intended to provide a brief, general description of suitable computer hardware and a suitable computing environment in conjunction with which the invention may be implemented. In some embodiments, the invention is described in the general context of computer-executable instructions, such as program modules, being executed by a computer. Generally, program modules include routines, programs, objects, components, data structures, etc., that perform particular tasks or implement particular abstract data types.

As noted above, the system as disclosed herein can be spread across many physical hosts. Therefore, many systems and sub-systems of FIG. 12 can be involved in implementing the inventive subject matter disclosed herein.

Moreover, those skilled in the art will appreciate that the invention may be practiced with other computer system configurations, including hand-held devices, multiprocessor systems, microprocessor-based or programmable consumer electronics, network PCs, minicomputers, mainframe computers, and the like. The invention may also be practiced in distributed computer environments where tasks are performed by I/O remote processing devices that are linked through a communications network. In a distributed computing environment, program modules may be located in both local and remote memory storage devices.

In the embodiment shown in FIG. 12, a hardware and operating environment is provided that is applicable to both servers and/or remote clients.

With reference to FIG. 12, an example embodiment extends to a machine in the example form of a computer system 1200 within which instructions for causing the machine to perform any one or more of the methodologies discussed herein may be executed. In alternative example embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. Further, while only a single machine is illustrated, the term “machine” shall also be taken to include any collection of machines that individually or jointly execute a set (or multiple sets) of instructions to perform any one or more of the methodologies discussed herein.

The example computer system 1200 may include a processor 1202 (e.g., a central processing unit (CPU), a graphics processing unit (GPU) or both), a main memory 1206 and a static memory 1210, which communicate with each other via a bus 1222. The computer system 1200 may further include a video display unit 1226 (e.g., a liquid crystal display (LCD) or a cathode ray tube (CRT)). In example embodiments, the computer system 1200 also includes one or more of an alpha-numeric input device 1230 (e.g., a keyboard), a user interface (UI) navigation device or cursor control device 1234 (e.g., a mouse), a disk drive unit 1238, a signal generation device (e.g., a speaker), and a network interface device 1214.

The disk drive unit 1238 includes a machine-readable medium 1239 on which is stored one or more sets of instructions 1240 and data structures (e.g., software instructions) embodying or used by any one or more of the methodologies or functions described herein. The instructions 1240 may also reside, completely or at least partially, within the main memory 1206 or within the processor 1202 during execution thereof by the computer system 1200, the main memory 1206 and the processor 1202 also constituting machine-readable media.

While the machine-readable medium 1239 is shown in an example embodiment to be a single medium, the term “machine-readable medium” may include a single medium or multiple media (e.g., a centralized or distributed database, or associated caches and servers) that store the one or more instructions. The term “machine-readable medium” shall also be taken to include any tangible medium that is capable of storing, encoding, or carrying instructions for execution by the machine and that cause the machine to perform any one or more of the methodologies of embodiments of the present invention, or that is capable of storing, encoding, or carrying data structures used by or associated with such instructions. The term “machine-readable medium” shall accordingly be taken to include, but not be limited to, solid-state memories and optical and magnetic media that can store information in a non-transitory manner, i.e., media that is able to store information for a period of time, however brief Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks.

The instructions 1240 may further be transmitted or received over a communications network 1218 using a transmission medium via the network interface device 1214 and utilizing any one of a number of well-known transfer protocols (e.g., FTP, HTTP). Examples of communication networks include a local area network (LAN), a wide area network (WAN), the Internet, mobile telephone networks, Plain Old Telephone (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible medium to facilitate communication of such software.

The above described invention is composed of many different components, most of which are known in the art. The inventive aspects are unique in combining the components in a manner in which has never previously been considered, and used to solve a compelling business need. Specifically, while the present invention uses classification systems as a component, numerous classification systems are known in the art. The inventive aspects of the present invention are not the classification systems proper, but rather the specific role the classification systems provide in a larger system including classification systems, topic models, “in-wild” relationship feedback, user attribute selection, and various output methods to a user of the system to emphasize the relationship recommendations. Thus, it is known by the inventors that individual components already exist in the art, but the combination of components as described herein is the inventive aspect.

While the present invention was described in the context of Facebook™, Twitter™, Wikipedia™, and others, as would be apparent from the review of the foregoing, the system and method of the present invention is applicable to other environments and implementations and provides a number of advantages. In order to further illustrate the advantages and facilitate an understanding of the present invention, a number of examples applicable to a social network system are provided below. These examples also illustrate other applications for the present invention.

### EXAMPLE 1

### Online Dating

Successful romantic relationships are challenging for many individuals to find. Successful pairs have a mixture of shared interests/attributes, complimentary interests/attributes, and divergent interests/attributes. Finding the correct match between individuals helps ensure long term relationship success and avoid emotionally and financially draining dissolution of the relationship.

Traditional methods of finding a romantic partner are fairly random and sometimes are initially driven by factors which can be contradictory to a long term relationship. Alternate approaches for dating using questionnaires attempt to alleviate some of the matching problems but don't correctly adapt to feedback biases. It is worth noting that the majority of questionnaire based approaches utilize self-reported data, whereas the described approach of looking at social data avoids built in observer bias.

By combining structured data (user surveys), semi-structured data (social graphs and data) and unstructured data (posts on social networks and other publicly available data), the system could analyze and report on personality match fit (extrovert/introvert compatibility, emotional stability, educational/intelligence levels, interests, etc.) as well as complimentary interests.

Interpersonal matching for romantic connections are limited by incomplete knowledge of each party, limited sets of potential partners in a given context, and artificial environments unrelated to ongoing relationship interactions. Applying the processing and storage power of cloud computing with machine learning techniques and applying that to large data sets of structured, semi-structured and unstructured data will provide results not possible using human methods.

### EXAMPLE 2

### Team Building

Effective teams have a variety of attributes including a set of skills that must be possessed by one or more members of the team as well as the ability to work cooperatively and communicate effectively, particularly in times of high stress.

Building effective teams using traditional methods that rely on resumes created by team members, manual questionnaires that introduce user bias and relying on human interviewers subject to their own skill/knowledge gaps and observer bias is both subjective and prone to error.

By combining structured data (user surveys), semi-structured data (social graphs and data) and unstructured data (team member resumes and other publicly available data), the system could analyze and report on personality match fit (extrovert/introvert compatibility, emotional stability, educational/intelligence levels, etc.) as well as skill set gaps and overlaps.

It is important to recognize that team choices are evaluated by the set of members of the team. While an ideal team may consist of, for example, a combination of technical, analytical, and social attributes in members, those attributes may span or be encompassed by one or more members. As such, an ideal team may be identified as composed of individuals A, B, C, and D. However, if individual D is unavailable then the next best combination may be individuals A, C, F, G, and H. It should be clear that individual skills are necessarily fungible and replacing one member of a team may require adjusting many, if not all, other members of the team.

Human abilities in this area are limited by both breadth of experience/application (length of career, number of people interviewed, etc.) and the ability to store and recall data about past experiences. Applying the processing and storage power of cloud computing with machine learning techniques and applying that to large data sets of structured, semi-structured and unstructured data will provide results not possible using human methods.

### EXAMPLE 3

### Hiring

Matching potential employees to jobs is a task that employers spend large sums of money on due to the organizational cost of hiring the wrong person for the job. In most ways similar to team building but with a different set of matching criteria. Specifically, with job matching the job applicant is searching for a matching open job position. Finding the proper match traditionally involves searching multiple job posting sources and applying to a position by providing only limited information to the potential employee in the form of a cover letter and resume. These must then be read by someone in a human resources department who may not know the actual matching criteria.

By combining structured data (job application), semi-structured data (social graphs and data) and unstructured data (resume, job description, etc.), the system could analyze and identify matching job postings for an individual's skills and experience. In addition, with the application of social graphs, the system could also identify if the applicant would be a good team match by comparing against other team members, bosses, any previous employees in a similar position, etc. Applications submitted via an application that vetted the relationship match between the job and the applicant could thus speed the hiring process while making it more accurate and efficient and thus less costly.

Human abilities in this area are limited by both the ability to interpret good matches and the ability to discover relevant job postings and applicants amongst the plethora of each. Applying the processing and storage power of cloud computing with machine learning techniques and applying that to large data sets of structured, semi-structured and unstructured data will provide results not possible using human methods.

It is important to recognize that Examples 2 and 3 are related and differ only in the focus of the pool upon which to draw. For Example 2 the potential team members are evaluated from a known universe of employees or other (e.g. military) potential members. For Example 3 the team member is the job applicant and the potential team matches are identified by job postings. Notably in this context, the term “team” could be interchanged with “organization”, “company”, “division”, or other social, business, education, or government constructs, and the method of selection could be selecting the team for a known individual or selecting an individual for a known team, as well as constructing complete teams from known individuals and other similar variations. As should be obvious to one of ordinary skill in the art, variations of Examples 2 and 3 would apply equally to admissions to universities, clubs, governments, or other organizations.

### EXAMPLE 4

### Advertising/Revenue Optimization

Finding affinity between a potential buyer and a product or service for sale is a very lucrative endeavor. Unfortunately, the traditional approaches have very limited insight into a potential buyer's interests. Often advertisements are pushed at potential buyers randomly. Some sophistication has been used to use demographic measures such as gender or age ranges to infer an interest in a product or service. More advanced techniques identify a potential affinity based upon an activity such as entering a search term or looking at a particular information item or web page. The most advanced techniques currently use a combination of these approaches.

Unfortunately, all existing methods fail to grasp whether or not a person is interested in purchasing, research, or some other activity. Similarly, the techniques fail to incorporate subtle indications that the user now expresses in free form text via their social networks. For example, a person may look at a product and express on her social network “I can't believe how bad this product is! I would never buy this!” Without access to the text, advertising directed at this person would be wasted effort and money. However, the converse is also true. Consider a person posting on his social network, “If only someone made a great widget, I would buy one for every member of my family!” In this case, an advertisement for widgets would be well targeted at this person.

Thus, by combining structured data (demographics), semi-structured data (social graphs and data) and unstructured data (social network posts and other publicly available text data), the system could analyze and report on advertising match fit (interested and able to buy, compatible styling and colors, etc.) as well as poor advertising matches.

Properly targeted advertising can save large sums of money for retailers by focusing on those most likely buyers. Applying the processing and storage power of cloud computing with machine learning techniques and applying that to large data sets of structured, semi-structured and unstructured data will provide results not possible using prior methods.

### EXAMPLE 5

### Product/Service Recommendation—Satisfaction Optimization

Similar to advertising matching, matching a product or service to an individual could be done instead to increase the satisfaction of the person receiving the recommendation. Even when an individual is not interested in purchasing an item or perhaps has already purchased the item, he may have an extended interest. For example, he may be interested in learning more about a favorite sports team or musical group. This may similarly apply to restaurants or other businesses where there is currently no advertising promotion active, but the person is interested in news items or other business activities.

By analyzing the same sorts of information as would be used for matching individuals to advertisements, the cloud computing with machine learning system could similarly match individuals to products or services they may be interested in. The focus for this relationship match is to increase the satisfaction of the person, not provide a more profitable advertising venue for the product or service provider.

### EXAMPLE 6

### Recommendation Differences Based Upon User Attributes

As described previously in the User Processing section, when a user requests a relationship match, depending upon that user's attributes they may receive different relationship suggestions. A single male who has posted about seeking romantic opportunities may receive an online dating relationship match. The same system may provide a married female who has been reading job postings and commenting about her desire for career advancement a set of matching job postings for her skills and interests. Similarly, the same application may display only summary information to a user who has not paid for relationship matching.

Any variety of matching combinations, including providing multiple distinct relationship types to an individual, would be reasonable extensions of this business workflow. Due to the amount of information available to the processing and storage capabilities of cloud computing with machine learning techniques as applied to large data sets of structured, semi-structured and unstructured data will provide numerous insights into the many and varied relationship needs of an individual.

### EXAMPLE 7

### Social Biography Teaser

As mentioned in the recommendation workflow example, this service could be offered as a pay service. However, a common method to entice non-paying interested parties is to offer a “teaser” amount of information. For example, upon registering for the application as a non-paying user, the user's information will be extracted and analyzed by the system, producing the user attribute vector(s). This information can then be summarized to the user by the system to illustrate the depth and quality of information available to make relationship matches.

Thus, the processed information may be presented to the non-paying user as a data-graphic or infographic of that user's personality type matches, commonly projected emotional state, interests and hobbies, and other similar personal information extracted from the variety of sources including social graph and free-text social network posts.

Alternately, the system may present to the non-paying user an abbreviated list of the best matches with their existing friends based on shared interests, personality, posting topics, emotional states, etc. These matches could potentially be sorted or separated by friendships and by potential romantic opportunities, for example.

From the foregoing, it will be seen that this invention is one well adapted to attain all the ends and objects hereinabove set forth together with other advantages which are obvious and which are inherent to the system and methodology. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The methods and systems described above and illustrated in the drawings are presented by way of example only and are not intended to limit the concepts and principles of the present invention. As used herein, the terms “having” and/or “including” and other terms of inclusion are terms indicative of inclusion rather than requirement.

What is claimed is:

1. A non-transitory computer-readable medium having computer-executable instructions that when executed, causes one or more processors to perform a method for combining data for identifying compatibility, the method comprising:
accessing at least one data source to extract data from said at least one data source that substantially merges all user data;
classifying said data using a classification system;
generating a data vector for said data;
storing said data vector in said classification system;
assessing a user attribute vector to said user data;
comparing said data vector and said user attribute vector to produce at least one relationship recommendation; and
providing to said user said at least one relationship recommendation.

2. The computer-readable medium of claim 1 wherein said classification system has machine learning capabilities including one of emotion detection and personality analysis.

3. The computer-readable medium of claim 1, further providing a positive or negative score for said at least one relationship recommendation based on a relationship matching tool emphasizing a natural relationship.

4. The computer-readable medium of claim 1 wherein social information is comprised within the data in said data source.

5. The computer-readable medium of claim 1 wherein said data source is comprised of unstructured text data.

6. A system for combining data to identify compatibility, having one or more processors being comprised within said system;
means for accessing at least one data source to extract data from said at least one data source that substantially merges all user data;
means for classifying said data using a classification system;
means for generating a data vector for said data;
means for storing said data vector in said classification system;
means for assessing a user attribute vector to said user data;
means for comparing said data vector and said user attribute vector to produce at least one relationship recommendation; and
means for providing to said user said at least one relationship recommendation.

7. The system as in claim 6 wherein said classification system has machine learning capabilities including one of emotion detection and personality analysis.

8. The system as in claim 6 further comprising providing a positive or negative score for said at least one relationship recommendation based on a relationship matching tool emphasizing a natural relationship.

9. The system as in claim 6 wherein social information is comprised within the data in said data source.

10. The system as in claim 6 wherein said data source is comprised of unstructured text data.

11. A system for combining data to identify compatibility,
one or more processors being comprised within said system;
at least one data source having data wherein said data may be extracted therefrom and wherein said data source substantially merges all user data;
a classification system wherein said data may be classified and a data vector generated and stored within said classification system;
a user attribute vector corresponding to said user data; and
at least one relationship recommendation being produced by comparing said data vector and said user attribute vector, said user being provided with said at least one relationship recommendation.

12. The system as in claim 11 wherein said classification system has a machine learning capabilities including one of emotion detection and personality analysis.

13. The system as in claim 11 further providing a positive or negative score for said at least one relationship recommendation based on a relationship matching tool emphasizing a natural relationship.

14. The system as in claim 11 wherein social information is comprised within the data in said data source.

15. The system as in claim 11 wherein said data source is comprised of unstructured text data.
